(19) United States
(12) Patent Application Publication
(10) Pub. No.: US 2025/0128920 A1
(43) Pub. Date: Apr. 24, 2025

(54) ELECTRIC HOIST

(71) Applicant: Zhejiang Nowvow Mechanical and Electrical Corp., Ltd., Zhejiang (CN)

(72) Inventors: LITIAN ZHANG, Zhejiang (CN); CHUNXIANG ZHANG, Zhejiang (CN); ENYA CHEN, Zhejiang (CN); ZIPENG WEI, Zhejiang (CN)

(21) Appl. No.: 18/816,154

(22) Filed: Aug. 27, 2024

(30) Foreign Application Priority Data
Oct. 20, 2023 (CN) 2023228626580
May 13, 2024 (CN) 2024210381174

(51) Int. Cl. B66D 1/12; B66D 1/38; B66D 1/54

(52) U.S. Cl. CPC B66D 1/12; B66D 1/38; B66D 1/54

(57) ABSTRACT

An electric hoist includes a housing, in the housing being provided a wire rope drum configured to store a wire rope, a friction clutch drum configured to drive winding and unwinding of the wire rope, and a rope guide configured to lead the wire rope to access the wire rope drum. The rope guide includes a rope guide base, a stationary guide roller, and a reciprocating shaft in transmission connection with the wire rope drum. The wire rope drum brings the reciprocating shaft to rotate. The reciprocating shaft controls the rope guide base to travel reciprocatively along an axial direction of the wire rope drum. The stationary guide roller is mounted on the housing at a position proximal to an end portion of the reciprocating shaft. The stationary guide roller leads the wire rope into the rope guide base.

### CROSS-REFERENCE TO RELATED APPLICATIONS AND CLAIM OF PRIORITY

This application claims the benefit under 35 USC § 119 of Chinese Patent Application Nos. 2023228626580, filed on Oct. 20, 2023, and 2024210381174, filed on May 13, 2024, in the China Intellectual Property Office, the entire disclosure of which is incorporated herein by reference for all purposes.

### BACKGROUND

### 1. Technical Field

The disclosure relates to the field of electric hoists, and more particularly relates to an electric hoist.

### 2. Background Art

An electric hoist is small lifting equipment that integrates an electric motor, a friction clutch drum, and a wire rope drum. To satisfy requirements of long-travel working conditions, a long wire rope needs to be stored in the wire rope drum. During rope winding, phenomena such as rope jamming, stacking, or tangling easily occur to the wire rope drum, so that the wire rope is likely damaged with reduced service life and increased operating hazards.

### SUMMARY

To overcome drawbacks of existing electric hoists in rope winding such as jamming, stacking, and tangling, an electric hoist is disclosed herein, which enables neater arrangement of the wire rope.

A technical solution below is described:

An electric hoist, including a housing, a wire rope drum configured to store a wire rope, a friction clutch drum configured to drive winding and unwinding of the wire rope, and a rope guide configured to lead the wire rope to access the wire rope drum, the wire rope drum, the friction clutch drum, and the rope guide being disposed in the housing, wherein the rope guide includes a rope guide base, a stationary guide roller, and a reciprocating shaft in transmission connection with the wire rope drum; the wire rope drum brings the reciprocating shaft to rotate; the reciprocating shaft controls the rope guide base to travel reciprocatively along an axial direction of the wire rope drum; the stationary guide roller is mounted on the housing at a position proximal to an end portion of the reciprocating shaft; the stationary guide roller leads the wire rope into the rope guide base.

The disclosure offers the following benefits:

The rope guide disclosed herein includes a rope guide base, a stationary guide roller, and a reciprocating shaft, the reciprocating shaft being in transmission connection with the wire rope drum; when the wire rope drum rotates to wind the wire rope, the reciprocating shaft drives the rope guide base to travel reciprocally along the axial direction of the wire rope drum; during rope winding of the wire rope drum, the wire rope will be arranged sequentially along the axial direction of the wire rope drum, and the rope guide base travels along the axial direction of the wire rope drum as the wire rope drum rotates; guided by the rope guide base, the fleet angle between the wire rope and the wire rope drum is maintained as vertical as possible, so that the wire rope is arranged more neatly and closely around the wire rope drum, which reduces occurrence of phenomena such as jamming, stacking, or tangling of the wire rope, thus effectively reducing damages to the wire rope and improving use safety of the electric hoist;

In addition, the stationary guide roller is mounted at the housing at a position proximal to an end portion of the reciprocating shaft, i.e., the rope guide base travels at one side of the stationary guide roller. The wire rope enters the rope guide base via the stationary guide roller. During travelling of the rope guide base, the bend angle of the wire rope is maintained within a fixed range, and the wire rope is only bent towards one direction; therefore, during rope arrangement, even if the wire rope swings, its bend angle still varies slightly when passing through the rope guide base; this can effectively lower the possibility of the wire rope reaching a bend extremity, thereby providing an effective protection to the wire rope and increasing service life of the wire rope; secondly, by guiding the wire rope to access the rope guide base via the stationary guide roller, the wire rope can enter the wire rope drum more stably, reducing swing amplitude of the wire rope, so that the wire rope is arranged more neatly and closely.

In some implementations, the stationary guide roller includes a first outlet for the wire rope to pass through; the rope guide base includes a second inlet for letting in the wire rope; and when the rope guide base travels to one end of the reciprocating shaft, the first outlet is aligned with the second inlet. With this technical solution, when the rope guide base travels to one end of the reciprocating shaft, the wire rope can access the rope guide base straightly and tautly, which may effectively reduce the maximum bend angle of the wire rope between the rope guide base and the stationary guide roller; this lowers the possibility of the wire rope reaching the extreme bend angle, lowers the possibility of damaging the wire rope, and renders safer operation of the wire rope.

In some implementations, the rope guide base is rotatably provided with a first pulley and a second pulley, a rotational axis of the first pulley being perpendicular to a rotational axis of the second pulley, the rotational axis of the first pulley being perpendicular to a rotational axis of the wire rope drum, the rotational axis of the second pulley being parallel to the rotational axis of the wire rope drum, the second pulley guiding the wire rope to the first pulley, the first pulley guiding the wire rope to be looped around the wire rope drum. With this technical solution, guiding via the first pulley and the second pulley can effectively reduce the swing amplitude of the wire rope so that the wire rope can be stably looped around the wire rope drum, resulting in neater and tighter arrangement of the wire rope around the wire rope drum, which prevents the wire rope from being jammed, stacked, or tangled.

In some implementations, the rope guide base includes a supporting frame, the supporting frame having a second inlet and a second outlet for the wire rope to pass through, the first pulley being disposed at the second outlet, the second pulley being disposed at the second inlet. With this technical solution, the wire rope enters from the second inlet of the supporting frame and exits from the second outlet; the second pulley can guide the wire rope to enter the second inlet, and the first pulley can guide the wire rope to enter the wire rope drum from the rope guide base; the first pulley and the second pulley can effectively lower the possibility of contacting between the wire rope and the supporting frame to thereby prevent friction between the wire rope and the supporting frame without damaging the wire rope.

In some implementations, a surface of the reciprocating shaft is formed with a double helix groove for the rope guide base to travel reciprocatively, both helixes of the double helix groove being formed at one side of the stationary guide roller, the wire rope between the rope guide base and the stationary guide roller being maintained parallel to the reciprocating shaft. With this technical solution, the rope guide base always travels at one side of the stationary guide roller, and the wire rope between the rope guide base and the stationary guide roller is maintained parallel to the reciprocating shaft; the bend angle of the wire rope after passing over the stationary guide roller maintains unchanged, so that the stationary guide roller constantly acts on the wire rope, which reduces variation of the bend angle of the wire rope and can further maintain stable contact between the wire rope and the stationary guide roller, whereby misalignment between the wire rope and the stationary guide roller is prevented and the wire rope travels more smoothly.

In some implementations, the housing is connected to an electrified electrical conductor, the electrical conductor being in electrically insulative connection with the housing; the wire rope has a tension segment maintained in a tensioned state; the electrical conductor is proximal to the tension segment, with a gap being formed between the electrical conductor and the wire rope; the wire rope with burrs formed contacts the electrical conductor to conduct electricity to the housing so as to electrify the housing; and an electricity tester configured to detect whether the housing is electrified is provided on the housing.

With this technical solution, a gap is formed between the electrical conductor and the wire rope; if the wire rope does not have a broken strand, the wire rope and the electrical conductor do not contact each other. The electrical conductor and the housing are connected in an electrically insulative manner. Therefore, if the wire rope does not have a broken strand, the housing would not be electrified; however, if the wire rope has a broken strand, burrs will be formed on the surface of the wire rope, so that when the wire rope passes over the electrical conductor, the burrs would contact the electrical conductor, electrifying the wire rope; since the housing is electrically connected to the electrical conductor via the wire rope, the housing is electrified; if the electricity tester detects that the housing is electrified, it indicates that the wire rope has burrs formed. This implementation can promptly detect presence of a broken strand via cooperation between the electrical conductor and the electricity tester, so that the user can overhaul and replace the wire rope in time, which also provides the user sufficient time for overhauling and replacement, thereby effectively preventing rope jamming due to the broken strand, significantly facilitating overhaul and replacement of the wire rope, and also preventing the wire rope from being broken due to the broken strand, whereby use safety of the electric hoist is enhanced. In addition, the wire rope has a tension segment where the wire rope maintains taut, which can effectively reduce the swing amplitude of the wire rope and further prevent the wire rope from contacting the electrical conductor due to the swing, thereby improving detecting precision of the electrical conductor.

In some implementations, the tension segment includes a first tension segment and a second tension segment, the first tension segment being disposed at a side of the stationary guide roller distant from the wire rope drum, the second tension segment being disposed at a side of the friction clutch drum proximal to the housing.

In some implementations, the electrical conductor includes a connecting end disposed at the stationary guide roller and a first detecting end configured to detect the wire rope, the first detecting end being formed with a through hole for the wire rope to pass through, a diameter of the through hole being greater than a diameter of the wire rope. With this implementation, the through hole allows for the wire rope to pass through normally and can also prevent the wire rope from direct contact with the first detecting end, whereby detection precision of the first electrical conductor can be improved. In addition, the wire rope passes through the through hole, so that the first detecting end surrounds the wire rope, which may extend the detection scope of the first detecting end, thereby increasing the possibility of contact between the burrs and the first detecting end and further enhancing detection precision of the first electrical conductor.

In some implementations, the first detecting end is formed with a notch communicating with the through hole, a width of the notch being greater than the diameter of the wire rope. With this technical solution, during replacement of the wire rope, the wire rope may directly disengage from the through hole of the first detecting end via the notch, without a need of dismantling the first electrical conductor and the wire rope, which facilitates replacement of the wire rope and enhances replacement efficiency of the wire rope.

In some implementations, the housing is detachably connected to a retaining base, the electrical conductor is mounted at the retaining base; an end of the electrical conductor proximal to the friction clutch drum is formed as a second detecting end; the second detecting end extends along an axial direction of the friction clutch drum; a presser and a reset member are provided on the retaining base, the presser abutting against the wire rope to maintain the wire rope tensioned, the reset member acting upon the presser so that the presser has a tendency of moving towards the wire rope. With this technical solution, the second detecting end extends along the axial direction of the friction clutch drum, which may extend the detection scope of the second detecting end, thereby significantly increasing the possibility of contacting between the second detecting end and the burrs, so that the electrical conductor can detect more timely whether the wire rope has burrs formed; the presser can press the wire rope tightly against the friction clutch drum causing the wire rope to maintain tensioned, further reducing swing amplitude of the friction clutch drum and preventing accidental contact with the electrical conductor due to swing of the wire rope.

In some implementations, the electricity tester is electrically connected to a protection switch; when the electricity tester detects that the housing is electrified, the protection switch controls a hoisting mechanism to stop operation, the hoisting mechanism being provided with an electric unlock device, the electric unlock device being configured to relieve limitation of the protection switch. With this technical solution, when the electrical conductor detects that the wire rope has burrs formed, the electricity tester detects that the housing is electrified and emits a signal to the protection switch, so that the protection switch controls the hoisting mechanism to stop operation, which may effectively prevent the wire rope from continuing lifting of the heavy object, lower the possibility of rope jamming or breaking, facilitate overhaul of the wire rope, and enhance operation safety of the hoisting mechanism; in addition, stopping operation of the hoisting mechanism via the protection switch enables the burrs on the wire rope to directly stop at the electrical conductor, so that the user can directly observe the condition of the wire rope, without a need of overhauling the entire wire rope, which may significantly enhance overhauling efficiency of the wire rope; secondly, when the protection switch shuts down the hoisting mechanism, the electric unlock device allows for re-activation of the hoisting mechanism, so that the wire rope can still lower the heavy object to the ground, whereby the wire rope enters the overhauling state.

In some implementations, a wire rope storage motor configured to drive the wire rope drum to rotate and a main motor configured to drive the friction clutch drum to rotate are further provided in the housing; the friction clutch drum includes a primary roller and a secondary roller; an output end of the main motor is in transmission connection with a speed reducer mechanism; and an output end of the speed reducer mechanism is in transmission connection with the primary roller.

In some implementations, the housing is further provided with a control system; the wire rope storage motor is provided with a first detector configured to detect an output torque of the wire rope storage motor; the main motor is provided with a second detector configured to detect an output torque of the main motor; the control system is connected to the wire rope storage motor and the main motor; and the control system controls respective output torques of the wire rope storage motor and the main motor based on detection results of the first detector and the second detector.

The other features and benefits of the disclosure will be illustrated in more detail through specific implementations described infra with reference to the accompanying drawings.

### BRIEF DESCRIPTION OF THE DRAWINGS

Hereinafter, the disclosure will be further explained through the accompanying drawings:

FIG. 1 is a structural schematic diagram of an electric hoist according to the disclosure;

FIG. 2 is a local enlarged view of the electric hoist according to the disclosure;

FIG. 3 is a structural schematic diagram of a wire rope drum and a rope guide in an electric hoist according to the disclosure;

FIG. 4 is a schematic diagram of a rope guide base traveling closer to a stationary guide roller in the electric hoist according to the disclosure;

FIG. 5 is a schematic diagram of the rope guide base traveling away from the stationary guide roller in the electric hoist according to the disclosure;

FIG. 6 is a structural schematic diagram of a wire rope drum, a rope guide, and a friction clutch drum in the electric hoist according to the disclosure;

FIG. 7 is a structural schematic diagram of a rope guide in the electric hoist according to the disclosure;

FIG. 8 is a local enlarged view of part A in FIG. 1;

FIG. 9 is a second structural schematic diagram of an electric hoist according to the disclosure;

FIG. 10 is a local enlarged view of part B in FIG. 9;

FIG. 11 is a structural schematic diagram of a second electrical conductor and a friction clutch drum in the electric hoist according to the disclosure;

FIG. 12 is a structural schematic diagram of the second electrical conductor in the electric hoist according to the disclosure;

FIG. 13 is a structural schematic diagram of a first electrical conductor in the electric hoist according to the disclosure.

### DETAILED DESCRIPTION OF EMBODIMENTS

Hereinafter, the technical solutions of the disclosure will be explained and illustrated through embodiments with reference to the accompanying drawings. However, the embodiments are only some embodiments of the disclosure, not all of them. Other embodiments obtained by those skilled in the art based on the examples in the embodiments without exercise of inventive work all fall within the protection scope of the disclosure.

In the description of the disclosure, it needs to be understood that the orientational or positional relationships indicated by the terms “center,” “longitudinal,” “transverse,” “length,” “width,” “thickness”, “upper,” “lower,” “front,” “rear,” “left,” “right,” “vertical,” “horizontal,” “top,” “bottom,” “inner,” “clockwise,” “counterclockwise,” etc. are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to the disclosure.

Besides, the terms “first” and “second” are only used for descriptive purposes, which shall not be construed as indicating or implying relative importance or implicitly indicating the amount of a referred to technical feature. Therefore, the features limited by “first” and “second” may explicitly or implicitly include one or more of such features. In the description of the disclosure, unless otherwise indicated, “plurality” indicates two or above.

In the disclosure, unless otherwise explicitly provided and limited, the terms such as “mount,” “connect,” “couple,” and “fix” should be understood broadly, which, for example, may refer to a fixed connection, a detachable connection, or an integral connection; which may be a mechanical connection or an electrical connection; which may be a direct connection or an indirect connection via an intermediate medium; which may also be a communication between the insides of two elements. To a person of normal skill in the art, specific meanings of the above terms in the disclosure may be construed based on specific situations.

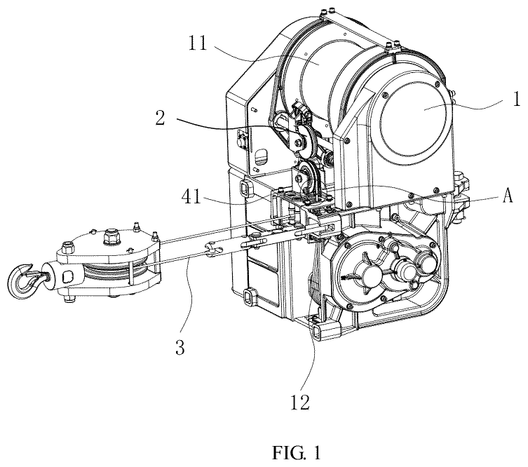

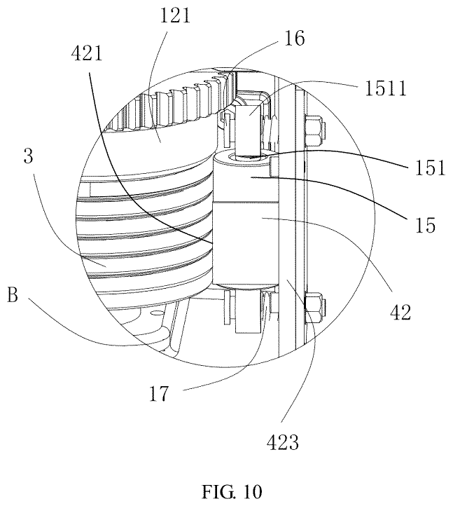

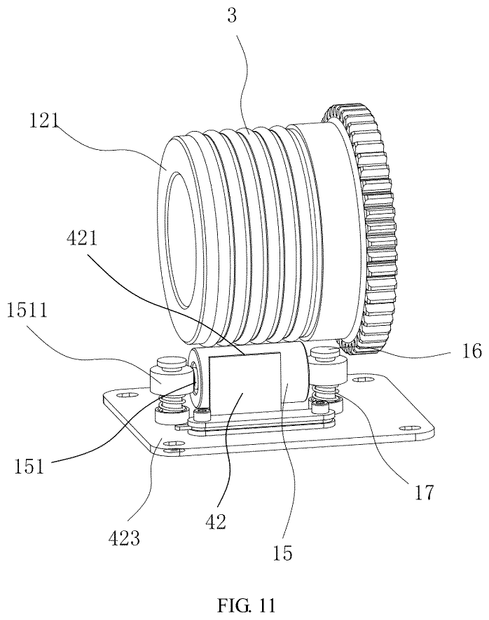

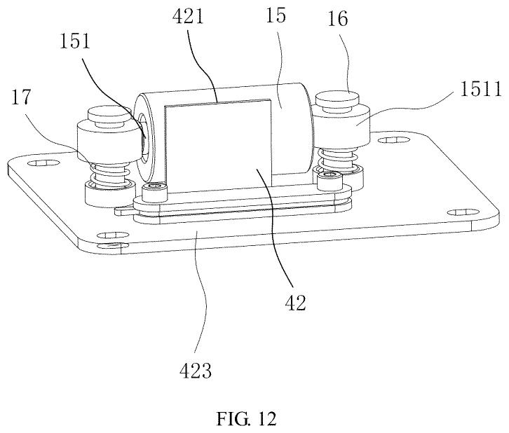

As illustrated in FIGS. 1 through 13, an implementation discloses an electric hoist, including a housing 1, inside the housing 1 being disposed a wire rope drum 11, a friction clutch drum 12, a control system, a wire rope storage motor, a main motor, and a rope guide 2; the friction clutch drum 12 includes a primary roller 121 and a secondary roller 122, a spiral rope groove being provided on a surface of the primary roller 121 and a surface of the secondary roller 122, respectively, a wire rope 3 being closely wound in the rope groove, a toothed portion being arranged at an end of the primary roller 121 and an end of the secondary roller 122, respectively, an output end of the main motor being attached with a speed reducer mechanism, an output end of the speed reducer mechanism being provided with a transmission gear, the transmission gear being disposed between the primary roller 121 and the secondary roller 122 and maintaining meshed with gears of both of the primary roller 121 and the secondary roller 122; after being activated, the main motor transfers dynamic energy to the transmission gear via which both of the primary roller 121 and the secondary roller 122 are driven to rotate; during rotating, the primary roller 121 and the secondary roller 122 drive the wire rope 3 to be raised and lowered via friction with the wire rope 3; in addition, the wire rope 3 is looped around the surface of the primary roller 121 and the surface of the secondary roller 122 by a plurality of turns; a larger number of turns may provide sufficient friction for the wire rope 3 and the friction clutch drum 12 so as to provide enough driving force for the wire rope 3 in lifting a leavy object.

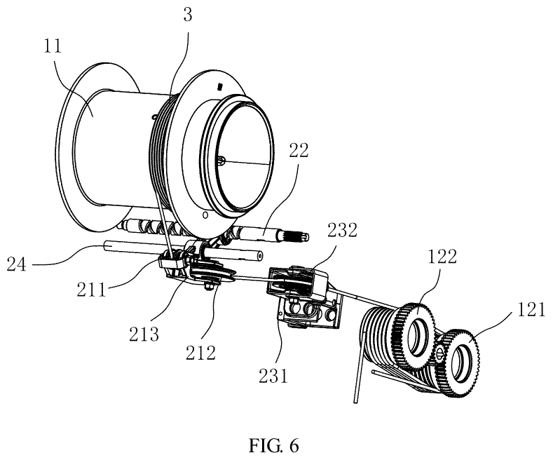

As illustrated in FIG. 1 and FIG. 6, in this implementation, the wire rope storage motor drives the wire rope drum 11 to rotate; the rope guide 2 is disposed between the wire rope drum 11 and the friction clutch drum 12; after passing over the friction clutch drum 12, the wire rope 3 extends till a rope guide base 21; the rope guide base 21 guides the wire rope 3 to be looped around the wire rope drum 11. In a case that the electric hoist is lifting a heavy object, the friction clutch drum 12 pulls the wire rope 3 upward so that the wire rope 3 carries the heavy object upward; meanwhile, the friction clutch drum 12 outputs the wire rope 3 to the wire rope drum 11, and the rope guide base 21 guides the wire rope 3 outputted by the friction clutch drum 12 to be stored in the wire rope drum 11 in which the wire rope 3 is looped around and arranged. In a case that the electric hoist is lowering a heavy object, the friction clutch drum 12 unwinds the wire rope 3 so that the wire rope 3 carries the heavy object downward; meanwhile, the friction clutch drum 12 pulls the wire rope 3 out of the wire rope drum 11; while the wire rope drum 11 is releasing the wire rope 3, the rope guide base 21 guides the wire rope 3 to the friction clutch drum 12 so that the rope groove on the friction clutch drum 12 always has the wire rope 3 looped around therein.

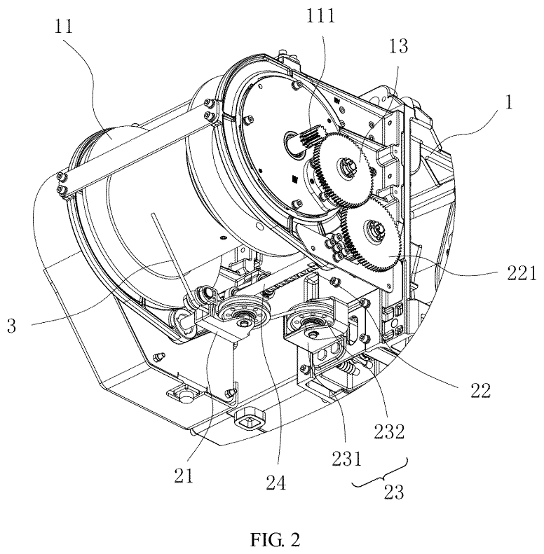

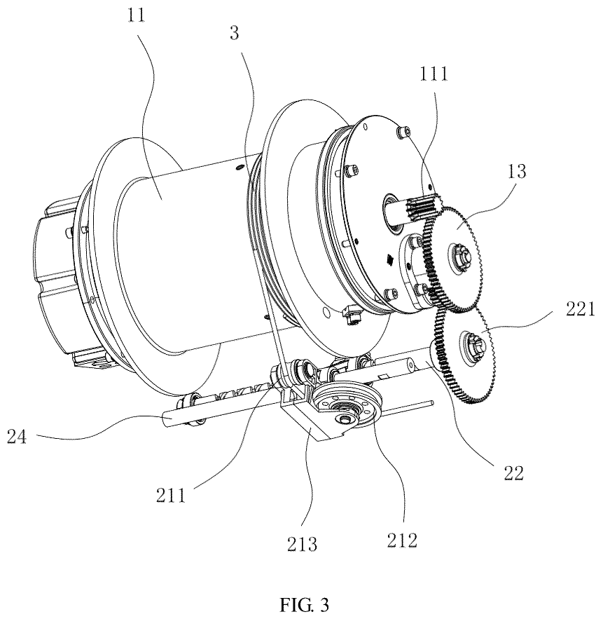

As illustrated in FIGS. 2 and 3, in this implementation, the rope guide 2 includes the rope guide base 21, a stationary guide roller 23, a guide rod 24, and a reciprocating shaft 22 that is in transmission connection with the wire rope drum 11. The rope guide base 21 is in sliding connection to both of the reciprocating shaft 22 and the guide rod 24; in addition, the reciprocating shaft 22 and the guide rod 24 are both parallel to the axial direction of the wire rope drum 11. The guide rod 24 can form a support to the rope guide base 21 and can also guide travelling of the rope guide base 21, enabling the rope guide base 21 to travel more stably and smoothly. A transmission assembly 13 is provided between the wire rope drum 11 and the reciprocating shaft 22. An output gear 111 is provided at an end of the wire rope drum 11, and a driven gear 221 is provided at an end of the reciprocating shaft 22, the transmission assembly 13 being in transmission connection with the output gear 111 and the driven gear 221, respectively. During rotating, the wire rope drum 11 drives, via the transmission assembly 13, the reciprocating shaft 22 to rotate, so that the rope guide base 21 travels reciprocally along the axial direction of the wire rope drum 11.

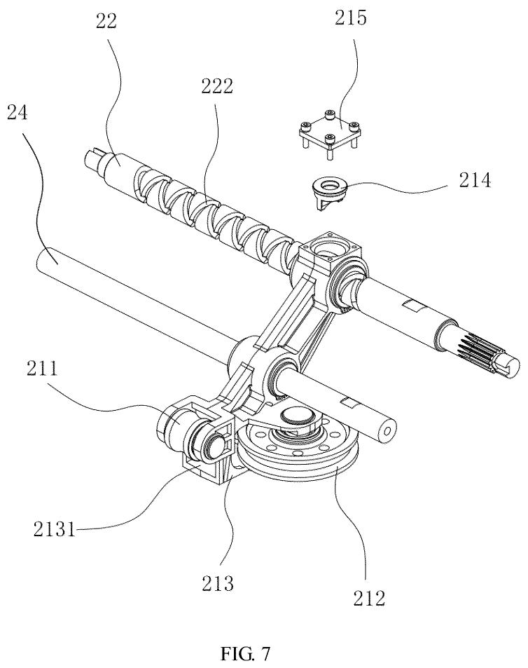

As illustrated in FIG. 3 and FIG. 7, in this implementation, the transmission assembly 13 includes a first gear and a second gear, the first gear being meshed with the output gear 111 of the wire rope drum 11, the second gear being meshed with the driven gear 221 of the reciprocating shaft 22. A double helix groove 222 is formed on the surface of the reciprocating shaft 22. The rope guide base 21 is provided with a sliding tongue 214 mated with the double helix groove 222 and a cover plate 215 for locating the sliding tongue 214. The sliding tongue 214 is inserted in the double helix groove 222. When the reciprocating shaft 22 is rotating, the double helix groove 222 is fitted with the sliding tongue 214 causing the rope guide base 21 to travel along the axial direction of the wire rope drum 11. In addition, a transmission ratio of the transmission assembly 13 may be set such that a travelling speed of the rope guide base 21 is matched with a looping speed of the wire rope drum 11. Guided by the rope guide base 21, the fleet angle between the wire rope 3 and the wire rope drum 11 can be maintained as vertical as possible, thereby improving loop neatness and precision of the wire rope 3 while lowering the possibility of damaging the wire rope 3.

As illustrated in FIG. 2, in this implementation, the stationary guide roller 23 is mounted in the housing 1 at a position proximal to an end of the reciprocating shaft 22, the stationary guide roller 23 guiding the wire rope 3 to access the rope guide base 21. The stationary guide roller 23 includes a mounting rack 231 and a third pulley 232 rotatably connected to the mounting rack 231. A first inlet and a first outlet for the wire rope 3 to pass through are formed on the mounting rack 231. The rope guide base 21 includes a second inlet 2132 and a second outlet 2131 for the wire rope 3 to pass through. When the rope guide base 21 travels to an end of the reciprocating shaft 22 proximal to the stationary guide roller 23, the rope guide base 21 is located at a front side of the stationary guide roller 23, with the first outlet being aligned with the second inlet 2132; the wire rope 3 passes over the stationary guide roller 23 to access the rope guide base 21 via the second inlet 2132; at this point, the wire rope 3, after passing over the stationary guide roller 23, does not bend; in addition, the wire rope 3 between the stationary guide roller 23 and the rope guide base 21 is perpendicular to the reciprocating shaft 22. When the rope guide base 21 travels along the reciprocating shaft 22 towards an end distant from the stationary guide roller 23, the wire rope 3 is bent after passing over the stationary guide roller 23, with a gradually enlarged bend angle.

In this implementation, the stationary guide roller 23 is mounted at the housing 1 at a position proximal to an end portion of the reciprocating shaft 22, i.e., the rope guide base 21 travels at one side of the stationary guide roller 23. The wire rope 3 enters the rope guide base 21 via the stationary guide roller 23. During travelling of the rope guide base 21, the bend angle of the wire rope 3 is maintained within a fixed range, and the wire rope 3 is only bent towards one direction; therefore, during rope arrangement, even if the wire rope 3 swings, its bend angle still varies slightly when passing through the rope guide base 21; this can effectively lower the possibility of the wire rope 3 reaching a bend extremity, thereby providing an effective protection to the wire rope 3 and increasing service life of the wire rope 3; secondly, by guiding the wire rope 3 to access the rope guide base 21 via the stationary guide roller 23, the wire rope 3 can enter the wire rope drum 11 more stably, reducing swing amplitude of the wire rope 3, so that the wire rope 3 is arranged more neatly and closely.

In addition, when the rope guide base 21 travels to one end of the reciprocating shaft 22, the wire rope 3 can access the rope guide base 21 straightly and tautly, which may effectively reduce the maximum bend angle of the wire rope 3 between the rope guide base 21 and the stationary guide roller 23; this lowers the possibility of the wire rope 3 reaching the extreme bend angle, lowers the possibility of damaging the wire rope 3, and renders safer operation of the wire rope 3.

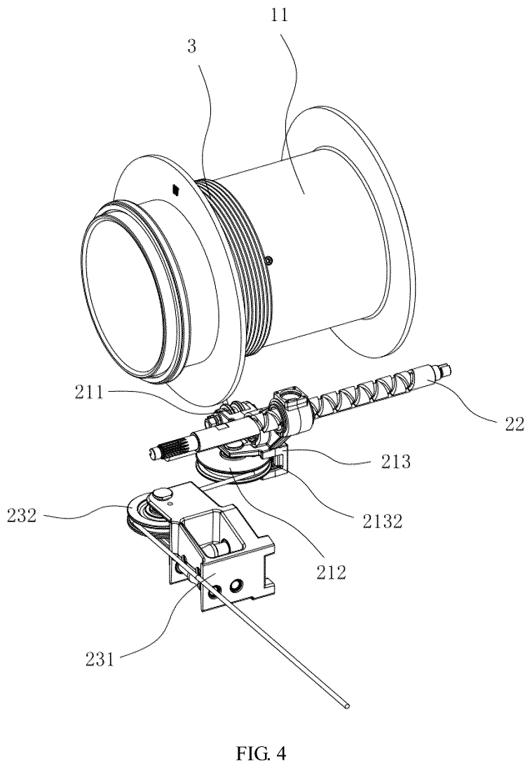

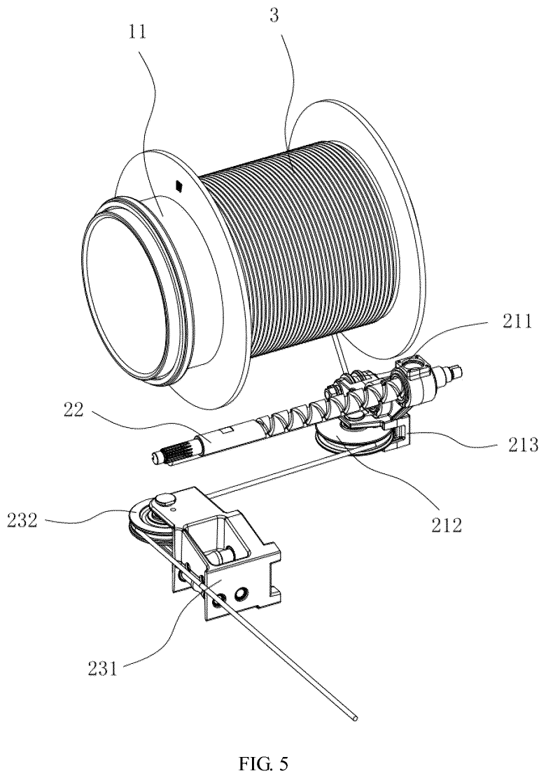

It is noted that, as illustrated in FIG. 4 and FIG. 5, in another implementation, both helixes of the double helix groove 222 may be located at one side of the stationary guide roller 23; when the rope guide base 21 travels to an end of the reciprocating shaft 22 proximal to the stationary guide roller 23, the rope guide base 21 is located at one side of the stationary guide roller 23, resulting in a small interval between a rear end of the second pulley 212 and a rear end of the third pulley 232. After passing over the third pulley, the wire rope 3 is bent along the third guide roller and extends till the second pulley 212. The wire rope 3 between the rope guide base 21 and the stationary guide roller 23 is maintained parallel to the reciprocating shaft 22. The rope guide base 21 always travels at one side of the stationary guide roller 23, and the wire rope 3 between the rope guide base 21 and the stationary guide roller 23 is maintained parallel to the reciprocating shaft 22. The bend angle of the wire rope 3 after passing over the stationary guide roller 23 maintains unchanged, so that the stationary guide roller 23 constantly acts on the wire rope 3, which reduces the variation degree of the bend angle of the wire rope 3 and can further maintain stable contact between the wire rope 3 and the stationary guide roller 23, whereby misalignment between the wire rope 3 and the stationary guide roller 23 is prevented so that the wire rope 3 travels more smoothly.

As illustrated in FIG. 7, in this implementation, the rope guide base 21 includes a supporting frame 213, a first pulley 211, and a second pulley 212, the supporting frame 213 having a second inlet 2132 and a second outlet 2131 for the wire rope 3 to pass through, the first pulley 211 being disposed at the second outlet 2132, the second pulley 212 being disposed at the second inlet 2132 and provided at a side of the supporting frame 213 facing the stationary guide roller 23. The wire rope 3 enters from the second inlet 2132 of the supporting frame 213 and exits from the second outlet 2131. The second pulley 212 can guide the wire rope 3 to enter the second inlet 2132, and the first pulley 211 can guide the wire rope 3 to enter the wire rope drum 11 from the rope guide base 21. The first pulley 211 and the second pulley 212 can effectively lower the possibility of contacting between the wire rope 3 and the supporting frame 213 to thereby prevent friction between the wire rope 3 and the supporting frame 213 without damaging the wire rope 3. In addition, the wire rope 3 enters the rope guide base 21 from the stationary guide roller 23; by disposing the second pulley 212 proximal to the stationary guide roller 23, the wire rope 3 can be timely led into the supporting frame 213, which further lowers the possibility of contacting between the wire rope 3 and the supporting frame 213 and prevents friction between the wire rope 3 and the supporting frame 213 without damaging the wire rope 3.

In addition, the wire rope drum 11, the first pulley 211, the second pulley 212, and the third pulley 232 each have a rotational axis, where the rotational axis of the first pulley 211 is maintained parallel to the rotational axis of the wire rope drum 11. The first pulley 211 guides the wire rope 3 to be looped around the wire rope drum 11 so that the fleet angle between the wire rope 3 and the wire rope drum 11 is maintained as vertical as possible. The rotational axis of the first pulley 211 is maintained perpendicular to the rotational axis of the second pulley 212 while parallel to the rotational axis of the wire rope drum 11. The second pulley 212 guides the wire rope 3 to the first pulley 211. Guiding via the first pulley 211 and the second pulley 212 can effectively reduce the swing amplitude of the wire rope 3 so that the wire rope 3 can be stably looped around the wire rope drum 11, resulting in neater and denser arrangement of the wire rope 3 around the wire rope drum 11, which prevents the wire rope 3 from being jammed, stacked, or tangled. The rotational axis of the third pulley 232 is maintained parallel to the rotational axis of the second pulley 212, so that the third pulley 232 can form a limitation to the wire rope 3; as such, the wire rope 3 can access the second pulley 212 from the third pulley 232 more stably and smoothly, thereby reducing swing amplitude of the wire rope 3 and lowering the possibility of the wire rope 3 disengaging from the third pulley 232.

To lower the possibility of the wire rope 3 reaching a bend extremity, in this implementation, the radius of the second pulley 212 is set to be greater than the extreme bend radius of the wire rope 3, and the radius of the third pulley 232 is set to be greater than the extreme bend radius of the wire rope 3; guiding via the second pulley 212 and the third pulley 232 can lower the possibility of the wire rope 3 reaching the extreme bend, which forms an effective protection to the wire rope 3, increases service life of the wire rope 3, and results in safer and more reliable operation of the electric hoist.

In this implementation, when the wire rope drum 11 rotates to wind the wire rope, the reciprocating shaft 22 drives the rope guide base 21 to travel reciprocally along the axial direction of the wire rope drum 11; during rope winding of the wire rope drum 11, the wire rope 3 will be arranged sequentially along the axial direction of the wire rope drum 11, and the rope guide base 21 travels along the axial direction of the wire rope drum 11 as the wire rope drum 11 rotates; guided by the rope guide base 21, the fleet angle between the wire rope 3 and the wire rope drum 11 is maintained as vertical as possible, so that the wire rope 3 is arranged more neatly and closely around the wire rope drum 11, which reduces occurrence of phenomena such as jamming, stacking, or tangling of the wire rope 3, thus effectively reducing damages to the wire rope 3 and improving use safety of the electric hoist.

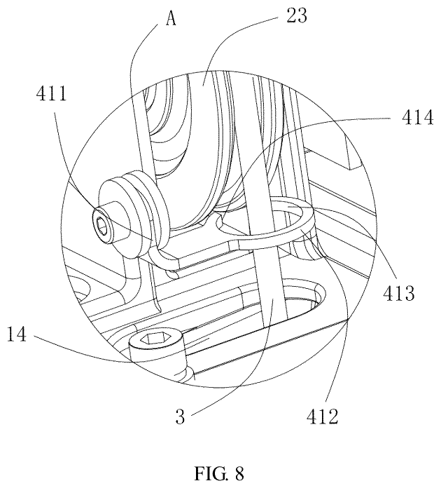

As illustrated in FIGS. 8 through 10, in this implementation, the housing 1 is connected to an electrified electrical conductor, the electrical conductor being connected to the housing 1 in an electrically insulative manner; the wire rope 3 has a tension segment maintained in a tensioned state; the electrical conductor is proximal to the tension segment, with a gap being formed between the electrical conductor and the wire rope 3; the burrs formed on the wire rope 3 contact the electrical conductor to electrify the housing 1; an electricity tester configured to detect whether the housing 1 is electrified is provided on the housing 1.

In this implementation, a gap is formed between the electrical conductor and the wire rope 3; without a broken strand, the wire rope 3 would not contact with the electrical conductor. The electrical conductor and the housing 1 are connected in an electrically insulative manner. Therefore, if the wire rope 3 does not have a broken strand, the housing 1 would not be electrified; however, if the wire rope 3 has a broken strand, burrs will be formed on the surface of the wire rope 3, so that when the wire rope 3 passes over the electrical conductor, the burrs would contact the electrical conductor, resulting in electrification of the wire rope 3; since the housing 1 is electrically connected to the electrical conductor via the wire rope 3, the housing 1 is electrified; when the electricity tester detects that the housing 1 is electrified, it indicates that the wire rope 3 has burrs formed. This implementation can promptly detect existence of a broken strand via cooperation between the electrical conductor and the electricity tester, so that the user can overhaul and replace the wire rope 3 in time, which also provides the user sufficient time for overhaul and replacement, thereby effectively preventing rope jamming caused by the broken strand, significantly facilitating overhaul and replacement of the wire rope 3, and also preventing the wire rope 3 from being broken by the broken strand, whereby use safety of the electric hoist is enhanced. In addition, the wire rope 3 has a tension segment where the wire rope 3 maintains taut, which can effectively reduce the swing amplitude of the wire rope 3 and can further prevent the wire rope 3 from contacting the electrical conductor due to the swing, thereby improving detecting precision of the electrical conductor.

In this implementation, when the electric hoist is lifting a heavy object, the wire

rope 3 outputted by the friction clutch drum 12 passes through a via hole 14 in the housing 1 to enter the stationary guide roller 23; the stationary guider 23 guides the wire rope 3 into the rope guide base 21. The rope guide base 21 travels along the axial direction of the wire rope drum 11 as the wire rope drum 11 rotates, so that the wire rope 3 can be looped around the wire rope drum 11 at a vertical angle. When the electric hoist is lowering a heavy object, the wire rope 3 is driven by the friction clutch drum 12 and pulled out under guidance of the rope guide base 21 and the stationary guide roller 23. The electrical conductor includes a first electrical conductor 41 and a second electrical conductor 42, and the tension segment includes a first tension segment and a second tension segment, the first tension segment being located between the stationary guide roller 23 and the via hole 14, the second tension segment being located at a side of the friction clutch drum 12 proximal to the housing 1, the first electrical conductor 41 being securely mounted to the stationary guide roller 23, the second electrical conductor 42 being securely provided at a side of the housing 1 proximal to the friction clutch drum 12. It is noted that, when the wire rope 3 is disposed at the first tension segment, the wire rope 3 is located between the wire rope drum 11 and the friction clutch drum 12. To enable the wire rope 3 to be stored in the wire rope drum 11 or to be pulled out of the wire rope drum 11, the wire rope 3 disposed at the first tension segment is always in a tensioned state, which prevents swinging of the wire rope 3 and thus prevents accidental contact with the first electrical conductor 41 due to swing of the wire rope 3. In addition, when the wire rope 3 is disposed at the second tension segment, the wire rope 3 is inserted in the rope groove of the friction clutch drum 12, so that the rope groove forms a limitation to the wire rope 3. Meanwhile, to drive the wire rope 3, the wire rope 3 is closely wound around the friction clutch drum 12 so that a larger friction force may be generated; therefore, the wire rope 3 at the second tension segment also does not swing easily, ensuring that accidental contact between the second electrical conductor 42 and the wire rope 3 does not easily occur.

It is noted that, in this implementation, the friction clutch drum 12 includes a primary roller 121 and a secondary roller 122, a toothed portion being provided at an end of the primary roller 121 and an end of the secondary roller 122, respectively, a main motor being disposed in the housing 1, an output end of the main motor being in transmission connection with a speed reducer mechanism, an end of the speed reducer mechanism being provided with a transmission gear, the transmission gear being disposed between the primary roller 121 and the secondary roller 122, the transmission gear being meshed with both of the toothed portion of the primary roller 121 and the toothed portion of the secondary roller 122. In addition, relative to the secondary roller 122, the primary roller 121 is disposed closer to the housing 1 so that the second tension segment is located at a side of the primary roller 121 proximal to the housing 1. Furthermore, in this implementation, the electric hoist further includes a control system, the control system being connected to a power source, the power source being electrically connected to the first electrical conductor 41 and the second electrical conductor 42 via a wire, respectively. The power source receives electrical energy from the control system, the electric energy being conducted to the first electrical conductor 41 and the second electrical conductor 42 via the wire to electrify the first electrical conductor 41 and the second electrical conductor 42. In a case that the wire rope 3 contacts the first electrical conductor 41 or the second electrical conductor 42 due to the burrs, the wire rope 3 is also electrified. Since the wire rope 3, the wire rope drum 11, the friction clutch drum 12, and the housing 1 are all electrical conductors and the wire rope 3 is connected to the housing 1 via the wire rope drum 11 or the friction clutch drum 12, electrification of the wire rope 3 results in electrification of the overall housing 1; therefore, when the burrs on the surface of the wire rope 3 contact the first electrical conductor 41 or the second electrical conductor 42, the electricity tester can detect that the housing 1 is electrified; to prevent the user from electric shock, a safe voltage, i.e., a voltage less than 36V, is supplied by the power source in this implementation.

As illustrated in FIG. 1 and FIG. 8, in this implementation, the first electrical conductor 41 includes an electrically insulating plate, a connecting end 411, and a first detecting end 412; the stationary guide roller 23 includes a mounting rack 231 and a third pulley 232, a rope groove matched with the wire rope 3 being formed on a peripheral side surface of the third pulley 232, the wire rope 3 being inserted in the rope groove and traveling along the third pulley 232, the electrically insulating plate being detachably connected to the mounting rack 231, a mounting portion configured to mount the connecting end 411 being provided on the electrically insulating plate, the connecting end 411 being detachably connected to the electrically insulating plate, which may further lower the difficulty of replacing the first electrical conductor 41, so that the user may replace the first electrical conductor 41 dependent on diameter and use requirement of the wire rope 3, whereby the application scope is extended.

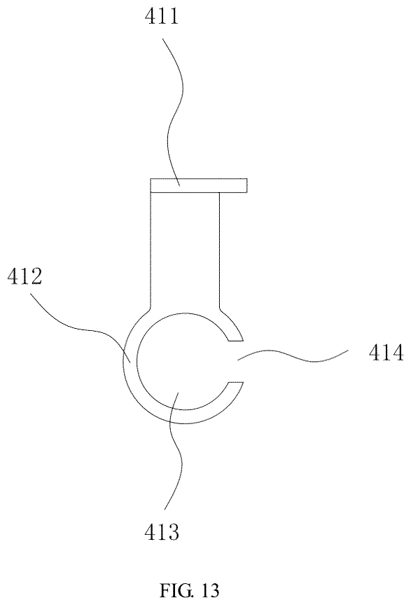

As illustrated in FIG. 13, in this implementation, the first detecting end 412 is formed with a through hole 413 for the wire rope 3 to pass through, the diameter of the through hole 413 being greater than the diameter of the wire rope 3; the first detecting end 412 is formed with a notch 414 in communication with the through hole 413, the width of the notch 414 being greater than the diameter of the wire rope 3. The through hole 413 allows for the wire rope 3 to pass through normally and can also prevent the wire rope 3 from direct contact with the first detecting end 412, whereby detection precision of the first electrical conductor 41 can be improved. In addition, the wire rope 3 passes through the through hole 413, so that the first detecting end 412 surrounds the wire rope 3, which may extend the detection scope of the first detecting end 412, thereby increasing the possibility of contact between the burrs and the first detecting end 412 and further enhancing detection precision of the first electrical conductor 41; secondly, during replacement of the wire rope 3, the wire rope 3 may directly disengage from the through hole 413 of the first detecting end 412 via the notch 414, without a need of dismantling the first electrical conductor 41 and the wire rope 3, which facilitates replacement of the wire rope 3 and enhances replacement efficiency thereof.

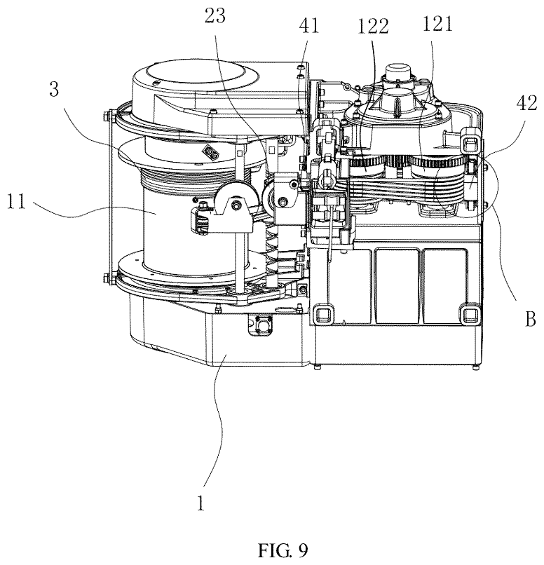

As illustrated in FIGS. 9 through 12, in this implementation, a retaining base 423 is provided at a side of the housing proximal to the friction clutch drum 12, the second electrical conductor 42 being secured to the retaining base 423, an end of the second electrical conductor 42 proximal to the friction clutch drum 12 is formed as a second detecting end 421; the second detecting end 421 extends along the axial direction of the friction clutch drum 12, which may extend the detection scope of the second detecting end 421, thereby significantly increasing the possibility of contacting between the second detecting end 421 and the burrs, so that the second electrical conductor 42 can detect more promptly whether the wire rope 3 has burrs formed. A presser and a reset member are provided on the retaining base 423, the presser including a pressure roller 15, the pressure roller 15 being rotatably connected to a rotary shaft 151, a connecting block 1511 being respectively provided at each of both ends of the rotary shaft 151, the connecting block 1511 being formed with a mounting hole for the bolt 16 to pass through, the bolt 16 passing through the mounting hole and being in threaded connection with the retaining base 423, further realizing mounting of the pressure roller 15. The reset member is a spring 17 sleeved over the bolt 16, two ends of the spring 17 abutting against the rotary shaft 151 and the retaining base 423, respectively. The presser abuts against the wire rope 3 to maintain the wire rope 3 taut. The reset member acts upon the presser so that the presser has a tendency of moving towards the wire rope 3. The second electrical conductor 42 is disposed at an upper side of the pressure roller 15.

During operation of the electric hoist, the friction clutch drum 12 rotates to drive the wire rope 3 to be raised or lowered; when the wire rope 3 passes over the pressure roller 15, the pressure roller 15 presses against the wire rope 3 so that the wire rope 3 is intimately attached inside the rope groove causing the wire rope 3 to maintain taut, further reducing swing amplitude of the friction clutch drum 12 and preventing accidental contact with the electrical conductor caused by swing of the wire rope 3. In addition, when the wire rope passes over the pressure roller 15, the pressure roller 15 rotates about the rotary shaft 151 as the wire rope 3 moves, so that rolling friction is generated between the wire rope 3 and the pressure roller 15, which lowers possibility of damaging the wire rope 3 and the pressure roller 15 due to friction and increases the service life of the wire rope 3 and the pressure roller 15; secondly, in a case of replacing a wire rope 3 of a different diameter, if the substituted wire rope 3 has a smaller diameter, the spring 17 is extended to act upon the connecting block 1511 so as to push the pressure roller 15 to move towards the friction clutch drum 12, holding the pressure roller 15 and the wire rope 3 to abut against each other; if the substituted wire rope 3 has a larger diameter, the wire rope 3 pushes the pressure roller 15 away from the friction clutch drum 12 causing the spring 17 compressed.

In this implementation, the electricity tester is electrically connected to a protection switch; if the wire rope 3 has burrs and the burrs contact the first electrical conductor 41 or the second electrical conductor 42, the electricity carried by the first electrical conductor 41 or the second electrical conductor 42 is conducted to the housing 1 via the wire rope 3; upon detecting that the housing 1 is electrified, the electricity tester emits an electrical signal to a controller of the electric hoist, so that the controller controls the main motor to be deactivated, further stopping the wire rope 3 from lifting or lowering the heavy object, which may reduce the possibility of jamming or breaking of the wire rope 3, lower the difficulty of overhauling the wire rope 3, and improve operational safety of the electric hoist. In addition, by deactivating the electric hoist via the protection switch, the burrs on the wire rope 3 can directly stop at the corresponding electrical conductor, so that the user can directly observe the condition of the wire rope 3, eliminating a need of overhauling the entire wire rope 3, whereby overhauling efficiency of the wire rope 3 may be significantly enhanced.

In addition, in this implementation, the electric hoist further includes an electric unlock device; when the electric hoist is deactivated by the protection switch, the user manipulates the electric unlock device so that the control system shields the electrical signal emitted by the protection switch, and the electric hoist can continue operation normally. If the electrical conductor detects burrs formed on the wire rope 3, it indicates that the wire rope 3 has a broken strand, and the wire rope 3 is still operable at this point. If the heavy object is already lifted or lowered in half air when the protection switch shuts down the electric hoist, by releasing the limitation of the protection switch using the electric unlock device, the electric hoist can be re-activated to lower the heavy object to the ground, so that the electric hoist may enter an overhauling state for replacing a new wire rope 3. In this implementation, an early-stage anomaly state of the wire rope 3 can be detected so that the electric hoist is immediately shut down with an alarm emitted. This prevents long-term operation of the anomalous wire rope 3, so that an accident due to break of the entire wire rope 3 would not occur, thereby significantly reducing safety hazards of the electric hoist.

In this implementation, a first electromagnetic brake and a first detector are provided in the wire rope storage motor, and a second electromagnetic brake and a second detector are provided in the main motor, the first detector being configured to detect an output torque of the wire rope storage motor in real time, the second detector being configured to detect an output torque of the main motor in real time, the control system being electrically connected to the wire rope storage motor and the main motor, the control system being configured to control the output torque of the wire rope storage motor and the output torque of the main motor based on respective detection results of the first detector and the second detector.

When a handlebar switch of the electric hoist transmits a rope-winding control signal to the control system, the control system, upon receipt of the rope-winding instruction, controls the main motor to drive the friction clutch drum 12 to rotate to wind the wire rope; the friction clutch drum 12 outputs the upward pulled wire rope 3 to the wire rope drum 11; the wire rope 3, after exiting the friction clutch drum 12, enters the stationary guide roller 23 and is guided by the stationary guide roller 23 to access the rope guide base 21; afterwards, the control system controls the wire rope storage motor to drive the wire rope drum 11 to rotate; the rope guide base 21 leads the wire rope 3 into the wire rope drum 11, where the wire rope 3 is looped around the surface of the wire rope drum; during the looping process, the rope guide base 21 travels along the axial direction of the wire rope drum 11 as the wire rope drum 11 rotates, so that the wire rope 3 is closely arranged along the axial direction of the wire rope drum 11.

During rope winding of the electric hoist, the first detector and the second detector detect the output torque of the wire rope storage motor and the output torque of the main motor, respectively, and transmit the detection results to the control system; the control system controls the output toque of the wire rope storage motor and the output torque of the main motor based on respective detection results of the first detector and the second detector, ensuring that the tension of the wire rope 3 between the wire rope drum 11 and the friction clutch drum 12 maintains constant; when the number of turns of the wire rope 3 looped around the wire rope drum 11 increases, the output torque of the wire rope drum 11 would change; the first detector transmits the detection result to the control system, so that the control system adjusts the rotating speed and the rotating torque of the wire rope storage motor, further ensuring that the tension of the wire rope 3 between the wire rope drum 11 and the friction clutch drum 12 maintains constant.

Furthermore, it is noted that, during rope winding, in a case that the surface of the wire rope 3 has burrs formed, when the burrs pass over the first electrical conductor 41 or the second electrical conductor 42, the burrs would contact the first electrical conductor 41 or the second electrical conductor 42, causing the wire rope 3 to be electrified by the first electrical conductor 41 or the second electrical conductor 42, the current being conducted to the entire housing 1 so that the housing 1 is electrified; when the electricity tester detects that the housing 1 is electrified, it transmits a shutdown signal to the protection switch, then the protection switch deactivates the main motor and the wire rope storage motor, further deenergizing the first electromagnetic brake and the second electromagnetic brake to hold braking, controlling the friction clutch drum 12 and the wire rope drum 11 to stop rotation, whereby the electric hoist stops.

When the handlebar switch of the electric hoist transmits a stop-winding control signal to the control system, the control system, upon receipt of the stop-winding instruction, controls the main motor to shut down and meanwhile controls the second electromagnetic brake to be deenergized to hold braking, which accelerates stop of the friction clutch drum 12, whereby the friction clutch drum 12 stops winding the rope; then, the control system controls the wire rope storage motor to shut down and controls the first electromagnetic brake to be deenergized to hold braking, so that the wire rope drum 11 stops rotation, and the electric hoist stops winding the rope.

When the handlebar switch of the electric hoist transmits a rope-unwinding control signal to the control system, the control system, upon receipt of a rope-unwinding instruction, controls the main motor to drive the friction clutch drum 12 to rotate to unwind the wire rope; the friction clutch drum 12 pulls the wire rope 3 out of the wire rope drum 11; the control system controls the wire rope storage motor to drive the wire rope drum 11 to rotate; the wire rope 3, after exiting the wire rope drum 11, enters the rope guide base 21, and under the guidance of the rope guide base 31, enters the stationary guide roller 23; the stationary guide roller 23 leads the wire rope 3 into the friction clutch drum 12; the friction clutch drum 12 unwinds the wire rope 3 so that the wire rope 3 lowers the heavy object.

During rope unwinding process of the electric hoist, the first detector and the second detector detect an output torque of the wire rope storage motor and an output torque of the main motor, respectively, and transmit respective detection results to the control system. The control system controls the output torque of the wire rope storage motor and the output torque of the main motor based on respective detection results of the first detector and the second detector; this ensures that the tension of the wire rope 3 between the wire rope drum 11 and the friction clutch drum 12 maintains constant; when the number of layers of the wire rope 3 looped around the wire rope drum 11 is reduced, the output torque of the wire rope drum 11 would change; the first detector transmits the detection result to the control system, and the control system adjusts the rotating speed and the rotating torque of the wire rope storage motor, further ensuring that the tension of the wire rope 3 between the wire rope drum 11 and the friction clutch drum 12 maintains constant.

When the handlebar switch of the electric hoist transmits a stop-unwinding control signal to the control system, the control system, upon receipt of the stop-unwinding instruction, controls the main motor to shut down, and meanwhile controls the second electromagnetic brake to be deenergized to hold braking, further accelerating stop of the friction clutch drum 12, so that the friction clutch drum 12 stops rope unwinding; then, the control system controls the wire rope storage motor to shut down and controls the first electromagnetic brake to be deenergized to hold braking, so that the wire rope drum 11 stops rotation, whereby the the electric hoist stops rope unwinding.

What have been described above are only embodiments of the disclosure; however, the protection scope of the disclosure is not limited thereto. A person skilled in the art should understand that the disclosure includes, but is not limited to, the contents described in the drawings and the embodiments. Any modifications without departing from the functions and structural principles of the disclosure will be included within the scope of the claims.

What is claimed is:

1. An electric hoist comprising:
a housing;
a wire rope drum configured to store a wire rope;
a friction clutch drum configured to drive winding and unwinding of the wire rope; and
a rope guide configured to lead the wire rope to access the wire rope drum, the rope guide comprising a rope guide base, a stationary guide roller, and a reciprocating shaft in transmission connection with the wire rope drum,
wherein the wire rope drum, the friction clutch drum, and the rope guide are disposed in the housing,
the wire rope drum is configured to bring the reciprocating shaft to rotate,
the reciprocating shaft is configured to control the rope guide base to travel reciprocatively along an axial direction of the wire rope drum,
the stationary guide roller is mounted on the housing at a position proximal to an end portion of the reciprocating shaft, and
the stationary guide roller is configured to lead the wire rope into the rope guide base.

2. The electric hoist according to claim 1, wherein the stationary guide roller comprises a first outlet for the wire rope to pass through;
the rope guide base comprises a second inlet for letting in the wire rope; and
when the rope guide base travels to one end of the reciprocating shaft, the first outlet is aligned with the second inlet.

3. The electric hoist according to claim 1, wherein the rope guide base is rotatably provided with a first pulley and a second pulley, a rotational axis of the first pulley being perpendicular to a rotational axis of the second pulley, the rotational axis of the first pulley being perpendicular to a rotational axis of the wire rope drum, the rotational axis of the second pulley being parallel to the rotational axis of the wire rope drum, the second pulley guiding the wire rope to the first pulley, the first pulley guiding the wire rope to be looped around the wire rope drum.

4. The electric hoist according to claim 3, wherein the rope guide base comprises a supporting frame, the supporting frame having a second inlet and a second outlet for the wire rope to pass through, the first pulley being disposed at the second outlet, the second pulley being disposed at the second inlet.

5. The electric hoist according to claim 1, wherein a surface of the reciprocating shaft is formed with a double helix groove for the rope guide base to travel reciprocatively, both helixes of the double helix groove being formed at one side of the stationary guide roller, the wire rope between the rope guide base and the stationary guide roller being maintained parallel to the reciprocating shaft.

6. The electric hoist according to claim 1, wherein the housing is connected to an electrified electrical conductor, the electrical conductor being in electrically insulative connection with the housing; the wire rope has a tension segment maintained in a tensioned state; the electrical conductor is proximal to the tension segment, with a gap being formed between the electrical conductor and the wire rope; the wire rope with burrs formed contacts the electrical conductor to conduct electricity to the housing so as to electrify the housing; and an electricity tester configured to detect whether the housing is electrified is provided on the housing.

7. The electric hoist according to claim 6, wherein the tension segment comprises:
a first tension segment disposed at a side of the stationary guide roller distant from the wire rope drum; and
a second tension segment disposed at a side of the friction clutch drum proximal to the housing.

8. The electric hoist according to claim 7, wherein the electrical conductor comprises:
a connecting end disposed at the stationary guide roller; and
a first detecting end configured to detect the wire rope, the first detecting end formed with a through hole for the wire rope to pass through, a diameter of the through hole being greater than a diameter of the wire rope.

9. The electric hoist according to claim 8, wherein the first detecting end is formed with a notch communicating with the through hole, a width of the notch being greater than the diameter of the wire rope.

10. The electric hoist according to claim 7, wherein the housing is detachably connected to a retaining base, the electrical conductor is mounted at the retaining base; an end of the electrical conductor proximal to the friction clutch drum is formed as a second detecting end; the second detecting end extends along an axial direction of the friction clutch drum; a presser and a reset member are provided on the retaining base, the presser abutting against the wire rope to maintain the wire rope tensioned, the reset member acting upon the presser so that the presser has a tendency of moving towards the wire rope.

11. The electric hoist according to claim 6, wherein the electricity tester is electrically connected to a protection switch; when the electricity tester detects that the housing is electrified, the protection switch controls a hoisting mechanism to stop operation, the hoisting mechanism being provided with an electric unlock device, the electric unlock device being configured to relieve limitation of the protection switch.

12. The electric hoist according to claim 1, further comprising:
a wire rope storage motor provided in the housing and configured to drive the wire rope drum to rotate; and
a main motor provided in the housing and configured to drive the friction clutch drum to rotate;
wherein the friction clutch drum comprises a primary roller and a secondary roller;
an output end of the main motor is in transmission connection with a speed reducer mechanism; and
an output end of the speed reducer mechanism is in transmission connection with the primary roller.

13. The electric hoist according to claim 12, further comprising a control system in the housing,
wherein the wire rope storage motor is provided with a first detector configured to detect an output torque of the wire rope storage motor,
the main motor is provided with a second detector configured to detect an output torque of the main motor,
the control system is connected to the wire rope storage motor and the main motor; and
the control system is configured to control respective output torques of the wire rope storage motor and the main motor based on detection results of the first detector and the second detector.
